(19) United States
(12) Patent Application Publication
(10) Pub. No.: US 2020/0126138 A1
(43) Pub. Date: Apr. 23, 2020

(54) SYSTEM AND METHOD FOR GENERATING COMPETITIVE REQUESTS FOR QUOTATIONS

(71) Applicant: Verified Supply Inc., Concord (CA)

(72) Inventor: BRENT MACKINNON, MISSISSAUGA (CA)

(21) Appl. No.: 16/658,042

(22) Filed: Oct. 19, 2019

Related U.S. Application Data
(60) Provisional application No. 62/748,478, filed on Oct. 21, 2018.

(51) Int. Cl. G06Q 30/06

(52) U.S. Cl. CPC G06Q 30/0611; G06Q 30/0621; G06Q 30/0627

(57) ABSTRACT

In a system and method for generating competitive quotations, a connection is made between a client and a request-for-quotation (RFQ) server. A product category is input at the client and the RFQ server generates a list of possible product attributes for products of that category. The client selects from the possible attributes. The RFQ host accesses a RFQ database to obtain vendor-product data for products of the category meeting the product attributes selection. The client compiles product data from the generated product data for an identified product and, when the compilation is complete, requests a quotation for the identified product. The RFQ host determines vendors of the identified product, generates a rules-based selection from those vendors, and presents at the client device quotations for the identified product from the selected vendors.

### FIELD OF THE INVENTION

The present invention relates generally to methods associated with commercial transactions and in particular to online access to product and/or services data that enable competitive review for the purpose of obtaining quotations (RFQs) from competing vendors.

### BACKGROUND

Obtaining quotations for products, whether for goods or services and whether for wholesale or retail, can be a time-consuming and frustrating affair, especially if an important prelude to obtaining such quotations is to perform a competitive analysis.

In the past a manual operation for generating competitive quotations had an intending buyer preparing an RFQ (also referred to as request for proposal or request for pricing) and mailing it to prospective vendors who would after a period of time respond with a price quotation. With the advent of the internet and the World Wide Web, an intending buyer will usually perform web searches using a preferred search engine. For example, if seeking a quote for a heavy duty vacuum pump for pumping water or aqueous solutions, the intending buyer might access an advanced search capability such as Advanced Google Search and then enter a combination of such search terms as “pump”, “vacuum”, “heavy duty” and “water”. This will throw up a host of results. Most of these will be websites for particular manufacturers, but there may also be sites where pump data from several manufacturers is aggregated. The intending buyer will then review the pump details from a particular manufacturer(s), often doing this by laboriously stepping through pages of a manufacturer's online catalog. The intending buyer will then identify pumps that are closest to possessing attributes which the buyer is seeking. For example, a pump may have a particular footprint, a particular maximum flow capacity, a particular output pressure, compatibility with other subsystems and components, be of heavy (or light) duty materials and components, and have a particular electrical system rating, etc. It may be equally important for the intending buyer to exclude pumps having a particular attribute which the buyer does not want. To obtain a comparative review, the buyer will search through product offerings of a number of manufacturers.

For an intending buyer having a particular requirement, then for each promising manufacturer or vendor, the buyer might contact a sales representative at the manufacturer or vendor to present the intending buyer's particular needs and to request a price quotation. The buyer requirement may be a single product or service or may be more complicated, such as a multi-product system. There will typically be some period of time before the prospective vendor is able to return to the buyer with a description of the nature of the product (or services) that the vendor can furnish and the proposed price. To avoid unnecessary delay, the buyer may request quotations from a number of manufacturers. Typically, quotations will come back from the prospective vendors at various times and there will inevitably be variation in what can be supplied by the different vendors. While some may offer exactly what the buyer seeks, others may offer a variation where a particular attribute is not available or where additional attributes not hitherto called for by the buyer are part of the offered product. Subsequently, the buyer will typically have discussions with each of the quoting vendors in order to get a full picture of each product offering and its price and in order to enable a competitive review to be performed. The whole process from beginning a search to inking a sales contract may take up to several months especially for complex and expensive systems.

It would be valuable to reduce the time and complexity of typical procedures for generating competitive quotations.

### SUMMARY OF THE INVENTION

According to one aspect of the invention, there is provided a method of generating competitive quotations comprising inputting a product category at a client device and responding at a request-for-quotation (RFQ) host connected to the client device by generating product data for products of the product category, generating a list of attributes for products of the product category, and presenting the product data and the list of attributes at the client device; selecting from the possible product attributes at the client device and responding at the RFQ host by filtering the presented product data according to the product attributes selection; compiling product data from the presented product data for an identified product at the client device and, when the compilation is complete, requesting the RFQ host to provide a quotation for the identified product; and responding at the RFQ host by determining vendors of the identified product, generating a rules-based selection of the vendors, and presenting quotations for the identified product from the selection of vendors at the client device.

A preferred feature of the invention is the ‘one click’ nature of the intending buyer's request for a quotation when the compilation is complete. The ‘one click’ results in a sequence of steps as indicated by the dashed line in FIG. 1, these steps being:
the previously entered intending buyer details are sent to the host together with the request for quotation for the identified product;
the RFQ host assigns a transaction tag;
the RFQ host determines vendors of the identified product;
the RFQ host subjects the vendors to a rules-based selection; and
the RFQ host presents to the intending buyer quotations for the identified product from one or more of the vendors as determined by the rules-based selection.

While the ‘one click’ may be effected using a computer mouse or similar input device, the input device may for example be a speech recognition device. Similarly, data including prompts and menus can be presented by the host to the intending buyer as a display or audio transaction or a combination of display and audio.

The method can further comprise, at the client device, selecting a preferred quotation from the presented quotations and, at the host, generating and issuing notification, thereof as by any of email, RFQ site issue or other delivery, to a prospective vendor corresponding to the preferred quotation.

For an intending buyer identifying a preferred product, the nexus of the intending buyer and the prospective vendor may be a starting nexus insofar as further refinement of the buyer needs, vendor offering and pricing may be made following follow-up negotiation between them. The method can further include the RFQ host initiating a routine to put the intending buyer and the preferred vendor into contact with one another to initiate such negotiation.

Preferably, the method further comprises, at initiation thereof, inputting intending buyer details at the client device and, wherein said requesting the RFQ host to provide quotations further prompts the RFQ host to record the intending buyer details and to generate a RFQ identifying tag and to associate the RFQ identifying tag with presented quotations.

Preferably, the rules of the rules-based selection include a rule related to proximity of the intending buyer to the product that is the subject of particular quotation. For example, a selection algorithm may promote a prospective vendor located within a range of 100 miles of the intending buyer or buyer's delivery site compared with a prospective vendor outside this range. In another alternative, a selection algorithm may limit products to those from prospective vendors in a specific location. The rules of the rules-based selection can additionally or alternatively include a rule related to price. For example, a selection algorithm may promote a prospective vendor having a lower price compared with other vendors having a higher price. The rules of the rules-based selection can additionally or alternatively include a rule for promoting vendors with whom the intending buyer is recorded as having had many and satisfactory prior transactions. The rules of the rules-based selection can additionally or alternatively include a rule related to a sponsored listing, where prospective vendors who have preferred status are promoted in comparison with vendors offering no sponsorship. In such circumstances, the results of the rules-based selection normally identify whether or not a prospective vendor holds sponsored status. The rules of the rules-based selection can additionally or alternatively include a rule related to vendor rating. The rules of the rules-based selection can additionally or alternatively include a rule related to vendor quality.

Preferably, the method includes a sub-routine permitting an aggregation of a number of different products in a single quotation. For example, an intending buyer can aggregate a plurality of similar products—for example, two or more vacuum pumps that are similar, but not the same, products. Tools made available by the RFQ host to the intending buyer at the client device can include a comparison application from presented product data related to a plurality of similar products to be compared, and from which comparison, the intending buyer can decide whether to request a quotation for one or both of the compared products. In another example, an intending buyer can aggregate a plurality of diverse products—for example, a vacuum pump, piping and control for a system. In the quotations presented to the intending buyer, quotations for each of the similar and diverse products can be provided from the rules based selections of competing vendors. A quotation for an aggregation of diverse products from one or more of the vendors can also be presented. The compilation of diverse and similar products is completed by the intending buyer before the step of requesting the RFQ host to provide quotations.

The method can be implemented for products, materials and systems (including hardware and software), for services (such as installation and repair), and for combinations of products and services.

Preferably, the host has connection capability and scheduler enabling connection to manufacturers' websites and cycling periodically through on-line product specification data.

While attribute sets will be somewhat tailored to the product category, some attributes data will be common to all product categories and will be obtained either from the website reading or subsequently on request to the vendor. Such essential attributes data can include product name, single product price, state (condition), stock keeping unit (SKU) and stock quantity. Other attribute data can be optional such as, for the example, for vacuum motors previously mentioned, voltage, horse power, manufacturer, noise level, vendor special or tier pricing, etc.

Downloaded vendor product specification data may be scanned in electronic or tangible media form for currently marketed products of a plurality of product categories. If not provided directly by the vendor, product data related to such products is interpreted to determine which of a plurality of possible attributes is possessed by the currently marketed products corresponding to the scanned product specifications, and the possessed attributes data is stored in association with a record of the products to which the attributes apply.

Preferably, for use in updating the stored product attributes database, a search engine at the RFQ host is programmed to cycle through sites previously visited to detect and fetch updates. The search engine can be programmed to explore new product offerings based on inputting data such as the identities of newly added suppliers/manufacturers. Preferably, an interpretation and translation module is located at the RFQ host to receive the output of the scanning module. The interpretation module can function to interpret scanned product data to determine product attributes and the translation module can function to store data corresponding to determined product attributes as standardized product attribute descriptors or keywords.

In one implementation of the invention, before a listing of product attributes for a particular product goes live, the spreadsheet entry is automatically directed to the associated vendor to obtain approval from the vendor as to accuracy of the RFQ data to be posted. In particular, the vendor is asked to make good any omission in the attribute listing, particular if pricing is not available from the vendor's site. Vendors receiving a significant number of RFQs through the RFQ site can be expected to adopt in product specification websites some of the standardized product attribute descriptors or keywords required by the RFQ site, thereby making it easier for the vendors' materials to be read, interpreted and translated. Adoption of common product attribute descriptors or keywords across a particular industry sector may also be more palatable for buyers insofar as it enables ‘apples to apples’ instead of ‘apples to oranges’ comparisons. Data storage and processing associated with the host may be located at a single website or may be distributed among a plurality of sites. Trusted vendors are also invited to access the RFQ attributes database directly and to update and add attribute sets for their current and new products.

The client device can be any of a smart phone, laptop computer, desktop computer, or similar device capable of data input and having display and/or audio output for presenting data, menus, prompts, etc., to the intending buyer. Connections between the client device and the host can be a dedicated line but are preferably internet connections using a web browser at the client device and links that are any of dial-up, digital subscriber line, cable/modem, wireless such as Wi-Fi, satellite and cellular.

The method contemplates alternatives to a hierarchy of a desired product category and possible product attributes for products of that desired product category such as, for example, a hierarchy of a desired product category, possible primary product attributes for products of that desired product category, and possible secondary product attributes for any or all of the primary product attributes.

According to another aspect of the invention, there is provided a system for generating competitive quotations comprising a client device having connection capability to a request-for-quotation (RFQ) server, the client device and the RFQ server programmed for: inputting a product category at the client device; generating a list of possible attributes for products of the product category at the RFQ server; selecting from the possible product attributes at the client device; generating product data for the product category according to the product attributes selection at the RFQ server; compiling product data from the generated product data for an identified product at the client device and, when the compilation is complete, for making a ‘one click’ request to the RFQ server to provide a quotation for the identified product; and the RFQ server further programmed for determining vendors of the identified product, for generating a rules-based selection of the vendors, and for presenting at the client device quotations for the identified product from the selected vendors.

### BRIEF DESCRIPTION OF THE DRAWINGS

FIG. 1 is a flow chart showing steps for a method according to one embodiment of the invention.

### DETAILED DESCRIPTION OF THE INVENTION INCLUDING THE PRESENTLY PREFERRED EMBODIMENTS

An RFQ method according to an embodiment of the invention can be implemented for products, materials, systems (including hardware and software), services (such as installation and repair), and for combinations of products and services.

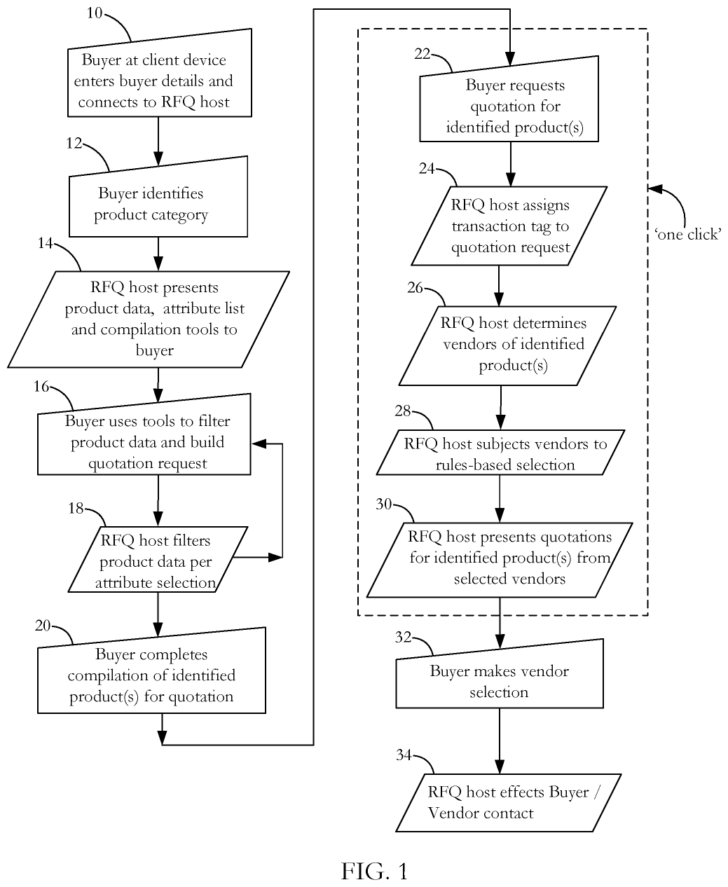

Referring to the flow chart of FIG. 1, a sequence of steps for the RFQ method is initiated at step 10 upon an intending buyer establishing a connection between an RFQ client device and a RFQ system host. The client device can, for example, be any of a smart phone, laptop computer, desktop computer, or similar device capable of data input and having display and/or audio output for presenting data, menus, prompts, etc., to the intending buyer. Connection between the client device and the RFQ host can, for example, be a dedicated line or internet connection with a link being for example any of dial-up, digital subscriber line, cable/modem, wireless, such as Wi-Fi, satellite and cellular.

The RFQ server presents a menu at the client to enable the intending buyer to enter data and commands needed in order to step through the RFQ method. The intending buyer enters intending buyer identity and contact details at the client device. At step 12, the intending buyer enters a product category such as ‘vacuum pumps’.

At step 14, in response to a product category being entered by the intending buyer, the RFQ host accesses a RFQ database and generates vendor-product data for products available in the product category. This is delivered to the client device, together with a previously prepared list of possible attributes for products in the product category and with compilation tools for use by the intending buyer. Some attributes are common to all product categories, these typically including product name, single product price, product condition, stock keeping unit (SKU) and stock quantity. Other attributes are tailored to the product category. Tailored or optional attribute information might include, for example, for the vacuum motors product category previously mentioned, voltage, horse power, manufacturer, noise level, vendor special or tier pricing, etc. In a variation of step 14, possible product attributes for products of the category, but not vendor product data for products of the category, are served to the client device.

At step 16, the intending buyer uses the compilation tools to develop a more focused view of products of interest. Selection from the possible attributes list transmitted from the RFQ server is an important part of this process step. In one embodiment, the selection is a single selection from the original attribute list. In another embodiment, the selection is a two phase process in which a selection for primary attributes is transmitted to the RFQ host, and from which a listing of subsidiary attributes is generated and sent to the client device. The intending buyer then makes a more refined attribute selection. In a further embodiment, the intending buyer has the option of listing the desired attributes in descending order of importance. In another embodiment, the intending buyer has the option of indicating attributes that are specifically not required

At step 18, the RFQ host filters product category data in the RFQ database according to the intending buyer's attribute selection. This may be a focused selection from vendor product data previously delivered to the client device in step 14. This data may be supplemented with product data not previously sent to the intending buyer at step 14 if the particular attribute selection warrants inclusion of product data in a related product category. The intending buyer is presented at the client device with a focused set of vendor-product data related to one or more products. The intending buyer at step 20 identifies one or more vendor-products of interest, completes compilation of relevant data at the client device, and at step 22 requests a quotation from the RFQ server.

At step 24, the intending buyer details are recorded at the RFQ host and a transaction tag is assigned to the RFQ request. At step 26, vendor-product data stored at the RFQ database is reviewed and all vendors of the product of interest to the intending buyer are identified. At step 28, a rules-based selection of the vendors is then generated at the RFQ host, this selection being presented at the client device together with quotations for the identified product from the selected vendors.

The rules governing the rules-based selection may include any of a variety of rules depending on commercial preference. One exemplary rule relates to proximity of the intending buyer to the product that is the subject of a particular quotation. For example, a selection algorithm promotes prospective vendor located within a range of 100 miles of the intending buyer or buyer's delivery site compared with prospective vendors outside this range. Another exemplary rule limits products to those from prospective vendors in a specific location; for example, the ‘home’ country. Another exemplary rule relates to price: more than, less than or within a price band. For example, the selection algorithm may promote a prospective vendor having a lower price compared with other vendors having a higher price. Another exemplary rule promotes vendors with whom the intending buyer is recorded as having had many and satisfactory prior transactions. Another exemplary rule relates to a sponsor listing in which prospective vendors having sponsor status are promoted in comparison with vendors offering no sponsorship. In such circumstances, the results of the rules-based selection normally identify whether or not a prospective vendor holds sponsor status. Another exemplary rule may relate to vendor rating and another to product quality. The above examples are not intended to limit the number or type of rules that may be applied using the method of the invention.

In an alternative embodiment of the invention, the RFQ method includes an optional sub-routine permitting an aggregation of a plurality of different products in a single quotation. For example, an intending buyer can aggregate a plurality of similar products—for example, two or more vacuum pumps that are similar, but not the same. The toolset made available by the RFQ host to the intending buyer includes a comparison application enabling the intending buyer to compare product data related to two or more similar products. From the comparison results, the intending buyer decides whether to request a quotation for one or the other of the compared products.

In a further alternative, the RFQ method offers a sub-routine permitting an aggregation of a plurality of diverse products—for example, a vacuum pump, piping and a control module for use in a system to be built using those diverse products. A quotation for an aggregation of diverse products each from a different vendor can also be requested at the client device and then generated at the RFQ. In the quotations presented to the intending buyer, quotations for each of the similar and diverse products is generated from the rules based selection of competing vendors. The compilation of aggregated diverse or similar products is completed by the intending buyer before a quotation is requested.

At step 32, the intending buyer selects a preferred vendor-product quotation from the presented quotations. In response at step 34, the RFQ server initiates a routine to put the intending buyer and the preferred vendor into contact with one another. For example, the RFQ server generates and issues a notification by, for example, email, RFQ site to vendor site link, or other delivery method, to the vendor corresponding to the preferred quotation.

For an intending buyer who has identified a preferred product and vendor, the nexus of the intending buyer and the prospective vendor may represent the culmination of the RFQ method which then proceeds directly to establishing payment for, and shipping of, the product. Alternatively, the nexus is a starting nexus insofar as there may not be a complete match between the intending buyer's product of interest and the vendor offering. In this instance, adjustment to one or more of the buyer product of interest, vendor offering and pricing may be made during follow-up negotiation between them.

A feature of a preferred embodiment of the invention is the ‘one click’ nature of the intending buyer's request for a quotation when the intended buyer has completed the menu driven compilation process. The ‘one click’ results in the sequence of steps contained in the dashed line in FIG. 1, these steps being:
the request for quotation for the identified product and intending buyer details are sent to the RFQ;
the RFQ host:
   assigns a transaction tag to the RFQ request;
   determines vendors of the identified product;
   subjects the vendors to the rules-based selection; and
   presents to the intending buyer quotations for the identified product from one or more of the vendors as determined by the rules-based selection.

While data input at the client device, including the ‘one click’ instruction, may be effected using a computer mouse, touch pad, soft keys or similar input device, the input may alternatively, for example, use a speech recognition device. Similarly, data including prompts and menus can be presented by the host to the intending buyer as a display or audio transaction or a combination of display and audio.

In order to enable effective implementation of the RFQ method, the RFQ vendor product database accessed through the RFQ server is built to contain whatever data is relevant to enable intending buyers to compile information required to generate RFQ requests for the product sought.

For each of product category, a supplier list is compiled together with the supplier names, contact details, products offered in the product category and product data for the products. The compiled information can be more comprehensive; for example, to indicate if a supplier will tailor products to buyer needs and to contain supplier review/satisfaction, the latter provided by past customers/buyers. Also, importantly, for each product, the RFQ database contains a field listing product attributes.

The RFQ vendor-product database, which is essentially the RFQ host catalog, is initially populated with vendors and their products for the difference target product categories. The RFQ database is then periodically updated. Vendor-product data may be obtained for populating the RFQ database in any of a number of ways. In one method, data is obtained automatically using web-scraper software to fetch and extract data from vendor websites showing currently marketed products. A scanning module at the RFQ host is used for accessing and reading product data written in pdf or other text form, or for accessing and directly reading product data stored in XML form. In another method, on-line data is manually inspected and relevant information extracted. Data is alternatively obtained in response to requests to vendors or as a result of the RFQ service provider holding discussions with vendors. In another method, product data is uploaded directly to an RFQ collection site directly by trusted vendors.

For use in updating the RFQ database, a search engine at the RFQ server is programmed to cycle through supplier sites previously visited to detect and fetch product data updates. In one implementation, the RFQ host has a connection capability and scheduler enabling connection to manufacturers' websites and cycling periodically through on-line product data. In one embodiment, the search engine is programmed to explore new product offerings based on inputting data such as the identities of newly added suppliers/manufacturers.

In concert with the populating of the RFQ database with vendor-product data, the database is populated with associated attributes data. The RFQ database attributes field is basically a simplified, standardized, certified extract from the product data. The RFQ product and attributes database is essentially the RFQ system catalog and must be populated and periodically updated with both current product data and current attribute data in order to stay relevant to interested buyers and vendors. Attribute information for populating the attribute field of RFQ database is obtained in a manner similar to the product data by inspecting that product data and assessing what attributes those products have. In an automatic method, interpretation and translation modules are located at the RFQ host. The interpretation module receives an output from the scanning module and functions to interpret scanned product data to determine product attributes. The translation module stores data corresponding to determined product attributes as standardized product attribute descriptors or keywords. The attribute allocation can also be performed, as with the product data by manual inspection, requests to vendors and vendor discussions. However performed, vendor product data is interpreted to determine which of a plurality of possible attributes is possessed by the products and the possessed attributes data is stored in association with product date for the products to which the attributes apply. Normally, the attribute data is compiled by the RFQ service provider independently of the relevant supplier. However, it can be prepared directly by a trusted supplier itself provided that naming and other protocols are followed. Trusted vendors may also be invited to upload attribute sets at the time of uploading the associated product data. In terms of attribute content, the attribute data may be stored and presented to the client device as a single flat file. In another embodiment of the invention, instead of a single list of attributes, the RFQ database is populated in a hierarchical manner. In one implementation, each of a set of primary attributes has an associated list of secondary attributes. Similarly, each of the set of secondary attributes can have an associated list of tertiary attributes. Attribute data generated from the analysis of the vendor-product data is organized in a spreadsheet format before uploading it to the RFQ host ‘catalog’ for access by client devices.

In one implementation of the invention, before the listing of product attributes for a particular product is made available from the RFQ server, the spreadsheet entry is automatically directed to the associated vendor to obtain approval from the vendor as to the accuracy of the RFQ data being posted including the appropriateness of the assigned attribute listing. The vendor is asked to make good any omission in the attribute listing, particular pricing if that is not present at the vendor's site.

Vendors receiving a significant number of RFQs through the RFQ system according to the present invention can be expected to adopt in product data websites some of the standardized product attribute descriptors or keywords required by the RFQ system, thereby making it easier for the vendors' materials to be read, interpreted, translated and posted to the RFQ database. Adoption of common product attribute descriptors or keywords across a particular industry sector may also be more palatable for intending buyers insofar as it enables ‘apples to apples’ instead of ‘apples to oranges’ comparisons.

Other variations and modifications will be apparent to those skilled in the art and the embodiments of the invention described and illustrated are not intended to be limiting. The principles of the invention contemplate many alternatives having advantages and properties evident in the exemplary embodiments.

What is claimed is:

1. A method of generating competitive quotations comprising:
establishing a connection between a client device and a request-for-quotation (RFQ) server;
at the client device inputting a product category;
at the RFQ server generating a list of possible attributes for products of the product category;
at the client device selecting from the possible product attributes
at the RFQ server generating product data for the product category according to the product attributes selection;
at the client device compiling product data from the generated product data for an identified product and, when the compilation is complete, making a ‘one click’ request to the RFQ server to provide a quotation for the identified product; and
at the RFQ server determining vendors of the identified product, generating a rules-based selection of the vendors, and presenting at the client device quotations for the identified product from the selected vendors.

2. The method as claimed in claim 1, further comprising the RFQ server generating an initial download of product data for the products of the product category when generating the list of possible attributes and filtering the initial download when generating product data according to the product attributes selection.

3. The method as claimed in claim 1, further comprising, at the client device selecting a preferred quotation from the presented quotations and, at the RFQ server generating and issuing notification, thereof as by any of email, RFQ site issue or other delivery, to a vendor corresponding to the preferred quotation.

4. The method as claimed in claim 1, further comprising inputting intending buyer details at the client device, wherein said requesting the RFQ host to provide quotations prompts the RFQ host to record the intending buyer details and to generate a RFQ identifying tag and to associate the RFQ identifying tag with the presented quotations.

5. The method as claimed in claim 1, wherein the rules of the rules-based selection include a rule related to one of proximity, price, prior RFQ transactions, vendor rating, vendor quality, sponsored listing.

6. The method as claimed in claim 1, wherein the method includes a sub-routine permitting an aggregation of a number of different products in a single quotation.

7. The method as claimed in claim 1, wherein the method includes a sub-routine permitting an aggregation of a number of similar products in a single quotation.

8. The method as claimed in claim 1, wherein the method is implemented for any one of products, materials, systems (including hardware and software), services (such as installation and repair), and any combinations thereof.

9. The method as claimed in claim 1, further comprising populating and periodically updating a vendor-product database with attribute data corresponding to products of prospective vendors.

10. The method as claimed in claim 9, further comprising the attribute data related to a product being uploaded directly to the attributes database by a vendor offering the product.

11. The method as claimed in claim 9, further comprising fetching on-line product specification data from a vendor's website, interpreting the website data and translating the interpreted data into attribute data.

12. The method as claimed in claim 11, further comprising cycling periodically through prospective vendors' websites to identify new and updated on-line product data for products of those vendors.

13. The method as claimed in claim 11, the RFQ host including a scanning module for reading on-line product specification data written in pdf or other text forms, and for accessing and directly reading product data stored in XML form.

14. The method as claimed in claim 9, wherein attribute data is organized into a spreadsheet format and uploaded to the RFQ host for availability to intending buyers.

15. The method as claimed in claim 8, wherein the attribute data is stored as attribute sets tailored respectively to the product categories.

16. The method as claimed in claim 14, each product for which product data is available at the RFQ host having an associated attribute set.

17. The method as claimed in claim 16, wherein the attribute set includes data for common attributes comprising any one of product name, single product price, state (condition), stock keeping unit (SKU) identification and in-stock quantity.

18. The method as claimed in claim 16, wherein the attribute set includes data for optional attributes comprising any of size, footprint, weight, capacity, materials, power rating, manufacturer, noise level, and vendor special or tier pricing.

19. The method as claimed in claim 1, wherein the attribute data is presented at the client device in hierarchical form comprising the desired product category, product attributes being primary attributes, optionally secondary product attributes for any or all of the primary product attributes and optionally tertiary product attributes for any or all of the secondary product attributes.

20. A system for generating competitive quotations comprising:
a client device having connection capability to a request-for-quotation (RFQ) server, the client device and the RFQ server programmed for;
inputting a product category at the client device;
generating a list of possible attributes for products of the product category at the RFQ server;
selecting from the possible product attributes at the client device;
generating product data for the product category according to the product attributes selection at the RFQ server;
compiling product data from the generated product data for an identified product at the client device and, when the compilation is complete, for making a ‘one click’ request to the RFQ server to provide a quotation for the identified product; and
the RFQ server further programmed for determining vendors of the identified product, for generating a rules-based selection of the vendors, and for presenting at the client device quotations for the identified product from the selected vendors.
